(19) United States
(12) Patent Application Publication
(10) Pub. No.: US 2022/0295814 A1
(43) Pub. Date: Sep. 22, 2022

(54) TEA COMPOSITIONS AND RELATED METHODS OF MANUFACTURE

(71) Applicant: Samantha Lyn Moreno, Las Vegas, NV (US)

(72) Inventor: Samantha Lyn Moreno, Las Vegas, NV (US)

(21) Appl. No.: 17/208,461

(22) Filed: Mar. 22, 2021

(51) Int. Cl. A23F 3/14; A23L 29/30; A23L 33/105

(52) U.S. Cl. CPC A23F 3/14; A23L 29/30; A23L 33/105

(57) ABSTRACT

The embodiments disclosed herein related to tea globes and related methods of manufacture. The tea globes can include an outer shell which can be formed from two hemispherical portions. The outer shell can be formed of an edible material and can be configured to dissolve in a liquid solvent. The outer shell can also be hollow and include one or more tea bags disposed therein. Loose leaf teas, powdered teas, or flowering/blooming teas can also be used. One or more of a Cannabis flower, concentrate, liquid, or extract can also be disposed in or within the outer shell. The thickness of the outer shell can vary to achieve a controlled opening of the outer shell and release of the contents disposed therein.

### TECHNICAL FIELD

The present disclosure relates to tea compositions and related methods of manufacture. More specifically, the present disclosure relates to compositions including tea disposed in an outer shell and methods of manufacturing the same.

### BRIEF DESCRIPTION OF THE DRAWINGS

The written disclosure herein describes illustrative embodiments that are non-limiting and non-exhaustive. Reference is made to certain of such illustrative embodiments that are depicted in the figures, in which:

FIG. 1 is a perspective view of a tea globe according to one embodiment of the present disclosure.

FIG. 2 is a cross-sectional view of the tea globe of FIG. 1.

FIG. 3 is another cross-sectional view of the tea globe of FIG. 1.

FIG. 4 is a side view depicting use of the tea globe of FIG. 1 according to one embodiment of the present disclosure.

FIG. 5 is a perspective view of a mold for manufacturing tea globes according to one embodiment of the present disclosure.

### DETAILED DESCRIPTION

It will be readily understood by one of skill in the art having the benefit of this disclosure that the components of the embodiments as generally described and illustrated in the figures herein could be arranged and designed in a wide variety of different configurations. Thus, the following more detailed description of various embodiments, as represented in the figures, is not intended to limit the scope of the present disclosure, but is merely representative of various embodiments. While various aspects of the embodiments are presented in drawings, the drawings are not necessarily drawn to scale unless specifically indicated.

The phrase “coupled to” is used in its ordinary sense, and is broad enough to refer to any suitable coupling or other form of interaction between two or more entities, including mechanical, fluid, and thermal interaction. Two components may be coupled to each other even though they are not in direct contact with each other. For example, two components may be coupled to each other through an intermediate component.

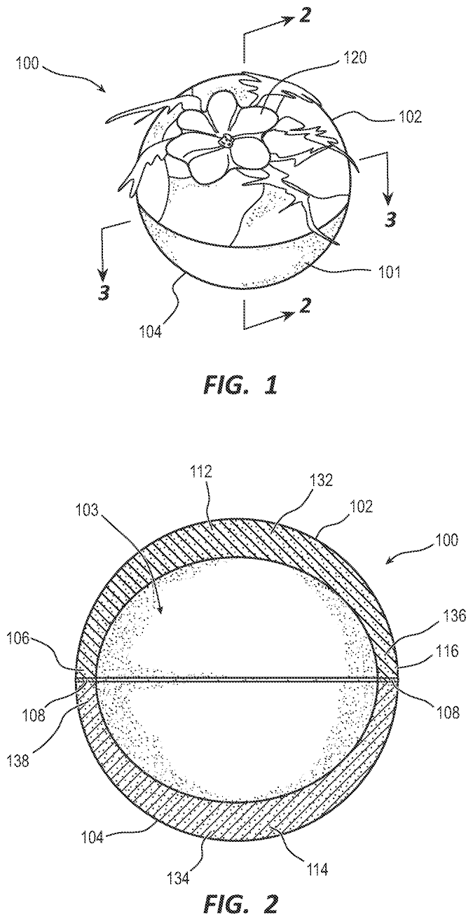

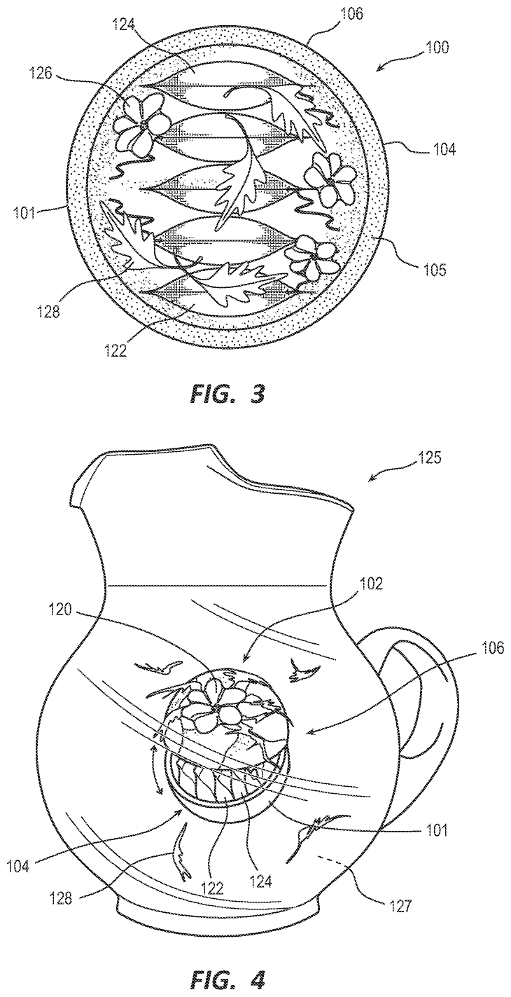

FIGS. 1-3 depict a tea globe 100 according to an embodiment of the present disclosure. More specifically, FIG. 1 is a perspective view of a tea globe 100; FIG. 2 is a cross-sectional view of the tea globe 100 taken vertically along view line 2-2 of FIG. 1 and depicts top and bottom portions 102, 104 of the outer shell 101 joined together; and FIG. 3 is a cross-sectional view of the tea globe 100 taken horizontally along view line 3-3 of FIG. 1 and depicts an upper surface 105 of an edge or rim of the bottom portion 104 of the outer shell 101. The tea globes 100 can also be generally referred to as tea compositions, tea spheres, tea bombs, tea balls, tea orbs, or tea drops.

As illustrated in FIGS. 1-3, the tea globe 100 includes an outer shell 101. In some embodiments, such as the illustrated embodiment, the outer shell 101 can be substantially spherical in shape. Other shapes are also contemplated. For instance, the tea globe 100 can substantially spheroidal, cuboidal, pyramidal, cylindrical, conical, polygonal, etc. Other three-dimensional shapes are also contemplated.

In some embodiments, the outer shell 101 is hollow inside. In other words, the outer shell 101 includes a hollow interior cavity or space 103. For instance, the outer shell 101 can include two or more pieces, shells, or portions 102, 104 that are coupled together to form a cavity or void 103. In the illustrated embodiment, for example, the outer shell 101 includes first and second portions 102, 104 that are joined or otherwise coupled together. In some embodiments, the first and second portions 102, 104 form halves of the outer shell 101. In particular embodiments, the first and second portions 102, 104 form substantially hemispherical halves of the outer shell 101. In other embodiments, the first and second portions 102, 104 do not form halves, as one portion may be larger and the other portion may be smaller. In yet further embodiments, the outer shell 101 may be formed of more than two portions 102, 104.

The outer shell 101 can be made of various materials. In some embodiments, the outer shell 101 is formed of an edible material. The outer shell 101 may also be soluble such that it dissolves in a liquid solvent such as water. Exemplary materials that can be used to form the outer shell 101 include, but are not limited to, glucose syrup, sugar, and a liquid solvent. Exemplary glucose syrups that can be used include corn syrup. Exemplary sugars that can be used include, but are not limited to, cane sugars, beet sugars, and combinations thereof. The sugars can also be organic and/or vegan if desired. Exemplary liquid solvents that can be used include water.

One or more additives can also optionally be added to the outer shell 101 as desired. For example, in some embodiments, the outer shell 101 includes one or more of sweetener(s), flavoring(s), spice(s), colorants (e.g., white or other colored food colorings), edible glitters, edible confetti, or combinations thereof. Exemplary sweeteners include, but are not limited to, honey and agave (e.g., agave syrup or nectar). Exemplary flavorings include, but are not limited to, vanilla and vanilla bean. Other flavorings can also be used. The outer shell 101 can also include one or more of a Cannabis concentrate, liquid (e.g., oil), or extract. In particular embodiments, the outer shell 101 includes one or more of a Cannabis concentrate, liquid (e.g., oil), or extract comprising CBD (cannabidiol) and/or THC (tetrahydrocannabinol). In other embodiments, no Cannabis concentrates, liquids, or extracts are used.

In some embodiments, the outer shell 101 is formed from a mixture that comprises glucose syrup (e.g., corn syrup), sugar (e.g., vegan sugar), and a liquid solvent (e.g., water). The liquid solvent (e.g., water) can be used during manufacture of the outer shell 101 but is not observable when the outer shell 101 is solidified and/or cured. In some embodiments, this mixture used to form the outer shell 101 can include between about 15% and about 35% by volume of glucose syrup, or between about 15% and about 30% by volume of glucose syrup. The mixture can also include between about 60% and about 85% by volume of sugar. The mixture can also include between about 5% and about 25% by volume of liquid solvent, or between about 5% and about 15% by volume of liquid solvent.

In some embodiments, the outer shell 101 is transparent such that any contents 122 disposed in the tea globe 100 can be observed through the outer shell 101. In other embodiments, the outer shell 101 is translucent or semitransparent. And in yet other embodiments, the outer shell 101 is opaque.

Additional colorants and/or decorative elements 120 can also be included in or on the outer shell 101 as desired. For instance, in some embodiments, the outer surface of the outer shell 101 is painted (e.g., airbrushed), coated, or otherwise colored with a colorant. The tea globe 100 can also include one or more decorative elements 120 disposed thereon. The one or more decorative elements 120 can be solely for decorative purposes, or can also be used to sweeten or add flavor to the tea globe 100. In the illustrated embodiment of FIG. 1, the one or more decorative elements 120 include flowers and leaves. Other types of decorative elements 120 that can be used include, but are not limited to, dried fruits, edible glitters, edible confetti, and the like.

FIG. 2 is a cross-sectional view of the tea globe 100 taken vertically along view line 2-2 of FIG. 1 and depicts the top and bottom portions 102, 104 of the outer shell 101. For illustration purposes, the void space or cavity 103 disposed within the outer shell 101 is shown empty and devoid of any contents 122. Further, the void space or cavity 103 is shown as extending into both portions 102, 104 of the outer shell 101. In such instances, the portions 102, 104 of the outer shell 101 can be referred to as being hollow, hollowed out, or as being hollow hemispheres. Notwithstanding, it will be appreciated that one or more contents 122 can be disposed in the void space or cavity 103 as further detailed below.

As shown in FIG. 2, the thickness of the outer shell 101 can vary at different portions thereof. With reference to the outer shell 101 as a whole, the upper region 112 and/or the lower region 114 have a greater thickness than the middle region 116. Further, the thickness of the outer shell 101 gradually decreases as it moves from the upper and/or lower regions 112, 114 towards the middle region 116. In some embodiments, the thickness of the upper and/or lower regions 112, 114 of the outer shell 101 is more than two times, three times, or four times greater than the thickness in the middle region 116.

In certain embodiments, the thickness of the upper and/or lower regions 112, 114 of the outer shell 101 is between about 0.3 mm and about 2 mm, and the thickness of the middle region 116 is between about 0.1 mm and about 0.5 mm. As further discussed below, this difference in thickness can aid in a controlled opening of the tea globe 100 when the tea globe 100 is disposed in a liquid.

With reference to each individual portion 102, 104 of the outer shell 101, the central region 132, 134 of the portion 102, 104 has a greater thickness than the edge or rim region 136, 138. Further, the thickness gradually decreases as it moves from the central region 132, 134 towards the edge or rim region 136, 138. In some embodiments, the thickness of the central region 132, 134 of the portion 102, 104 of the outer shell 101 is more than two times, three times, or four times greater than the thickness at the edge or rim 136, 138. In certain embodiments, the thickness of the central regions 132, 134 of the portion 102, 104 of the outer shell 101 is between about 0.3 mm and about 2 mm, and the thickness at the edge or rim 136, 138 is between about 0.1 mm and about 0.5 mm.

FIG. 2 also depicts the interface 108 between the first and second portions 102, 104 in the middle region 106 of the tea globe 100. In some embodiments, the first and second portions 102, 104 are coupled to one another at this interface 108. For instance, in certain embodiments, an adhesive is applied to an upper surface 105 of the edge or rim 136, 138 of one or both of the first and second portions 102, 104. Opposing edges or rims 136, 138 of the first and second portions 102, 104 can thereafter be coupled, joined, or otherwise adhered together. In some embodiments, the adhesive is an edible adhesive. For instance, a composition including sugar, or a composition the same as or similar to the composition used to form the outer shell 101 (e.g., glucose syrup, sugar, and liquid solvent), can be used as an adhesive. For instance, the composition (as a liquid) can be applied to the upper surface 105 of the edge or rim 136, 138, or the upper surface 105 of the edge or rim 136, 138 can be dipped into the composition (as a liquid). The liquid composition can thereafter dry, solidify, or cure to couple the portions 102, 104 together. In other embodiments, a separate adhesive composition is not used to couple the portions 102, 104 together. In such embodiments, the upper surface of the edge or rim 136, 138 of one or both of the first and second portions 102, 104 can be heated such that it becomes tacky or sticky. The first and second portions 102, 104 can thereafter be coupled, joined, or otherwise adhered after which the tacky or sticky region can dry, solidify, or cure.

FIG. 3 is a cross-sectional view of the tea globe 100 taken horizontally along view line 3-3 of FIG. 1 and depicts an upper surface 105 of the edge or rim of the second portion 104 of the outer shell 101. In other words, FIG. 3 depicts a cross-sectional view near or along the interface 108 area. As shown therein, the thickness of the upper surface 105 remains substantially constant around the edge or rim of the second portion 104. In other words, the thickness of the outer shell 101 remains substantially constant around the middle region 106 of the tea globe 100.

FIG. 3 further depicts contents 122 disposed within the outer shell 101. Exemplary contents 122 that can be used include, but are not limited to, one or more tea bags 124 and one or more additives 126, 128. In the illustrated embodiment, the contents 122 include five tea bags 124. More or less tea bags 124 can also be used depending on the desired size of the tea globe 100. For instance, in certain embodiments, one tea bag 124 is used. In other embodiments, two, three, or four tea bags 124 are used. In yet further embodiments, six or more tea bags 124 are used. In other embodiments, loose leaf teas, powdered teas, or flowering/blooming teas are used in addition to or in place of the tea bags 124. Any variety and/or flavor of tea can also be used, including, but not limited to, herbal teas, black teas, green teas, white teas, yellow teas, oolong teas, post-fermented teas, etc. In yet further embodiments, coffee (e.g., coffee grounds) are disposed within the outer shell 101 in place of tea. For instance, coffee (e.g., coffee grounds) can be disposed within one or more bags (similar to the tea bags 124) that are placed within the outer shell 101.

The contents 122 of the tea globe 100 in FIG. 3 further include one or more additives 126, 128. Exemplary additives 126, 128 that can be used, include, but are not limited to, flavorants, sweeteners, colorants, herbs, flowers, leaves, sprinkles, edible glitter (e.g., prism powder), edible confetti, decorative elements, and combinations thereof. For instance, in the illustrated embodiment, the additives 126, 128 include one or more flowers 126 and one or more herbs 128. The contents 122 of the tea globe 100 can also optionally include one or more of a Cannabis flower, concentrate, liquid (e.g., oil), or extract. In particular embodiments, the contents 122 include one or more of a Cannabis flower, concentrate, liquid (e.g., oil), or extract comprising CBD (cannabidiol) and/or THC (tetrahydrocannabinol). In other embodiments, no Cannabis flowers, concentrates, liquids, or extracts are used.

FIG. 4 depicts an embodiment of using a tea globe 100 to make a drink or beverage. As shown therein, the tea globe 100 can be disposed or otherwise submerged in a liquid 127 such as water. The liquid 127 such as water can be in a pitcher 125, kettle, cup, or another type of beverage container. In some embodiments, the tea globe 100 begins to dissolve at or near the middle region 106, or the region having the lowest thickness. In certain embodiments, the tea globe 100 begins to dissolve at the interface 108 between the first and second portions 102, 104 for a substantially controlled opening of the outer shell 101. For instance, the tea globe 100 can dissolve at the middle region 106 or interface 108 first to controllably open and release its contents 122 into the liquid 127. As shown in FIG. 4, for example, as the outer shell 101 begins to dissolve or otherwise open, the contents 122 of the tea globe 100 are released into the liquid 127. In the illustrated embodiment, herbs 128 have been released into the liquid 127. The tea bags 124 are still shown within the outer shell 101 and will be released as the tea globe 100 continues to open. The contents 122 can thereafter impart their flavoring and/or characteristics to the liquid 127. As shown in FIG. 4, the one or more decorative elements on top of the tea globe 100 can also be released into the liquid 127. If desired, the liquid 127 can be mixed to increase the release rate of the contents 122 into the liquid 127. Mixing the liquid 127 can also be used to increase the dissolution rate of the outer shell 101. As can be appreciated, mixing the liquid 127 can further distribute the flavoring or other components throughout the liquid 127 and/or container (e.g., pitcher 125). If desired, the liquid 127 can also be heated (or be otherwise hot) to increase the dissolution rate of the outer shell 101. The beverage can thereafter be consumed at the user's discretion.

Methods of manufacturing tea globes 100 are also disclosed herein. In some embodiments, manufacturing tea globes includes forming an outer shell 101. In forming the outer shell 101, one or more materials, ingredients, or components can be combined to form a mixture. For example, in some embodiments, a mixture is formed comprising glucose syrup, sugar, and a liquid solvent. One or more additional additives, including, but not limited to, sweetener(s), flavoring(s), spice(s), colorants, edible glitters, edible confetti, Cannabis concentrates, oils, or extracts can also be included as set forth above. The mixture can then be heated to a temperature of between about 290° F. and about 310° F., or between about 295° F. and about 305° F. In some embodiments, the mixture is heated to a hard crack temperature. The mixture can also be heated such that it is boiling. In certain embodiments, the heated mixture can comprise a substantially homogenous liquid composition in which the sugars within the mixture have been dissolved.

After heating and mixing, the mixture can be cooled (e.g., removed from heat). For example, the mixture can be cooled to a temperature where the mixture is no longer boiling. In some embodiments, the mixture is cooled to a temperature of between about 250° F. and about 290° F., or between about 270° F. and about 285° F. If desired, one or more additional additives, including, but not limited to, sweetener(s), flavoring(s), spice(s), colorants, edible glitters, edible confetti, Cannabis concentrates, oils, or extracts can also be included during this step.

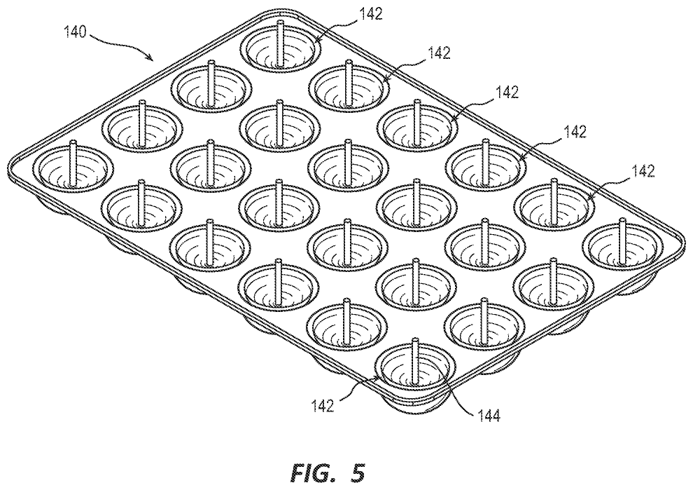

Prior to the solidifying, the mixture can be poured into or otherwise applied to a mold 140. An exemplary mold 140 that can be used is depicted in FIG. 5. A shown therein, the mold 140 includes a plurality of cavities or voids 142 into which the mixture can be disposed. Other types of molds can also be used. In some embodiments, the mixture is poured into the mold 140. In other embodiments, the mixture is injected into the mold 140. In yet other embodiments, the mixture is painted or otherwise coated onto one or more surfaces of the mold 140. In certain embodiments, the mixture is poured or otherwise applied to one or more sides of the cavities 142 within the mold 140 such that the mixture flows down the sides of the cavities 142 and towards the bottom or central regions of the cavities 142. In such embodiments, the surfaces of the cavities are coated as the mixture flows down the sides and towards the bottoms of the cavities. Further, the flow of the mixture from the sides of the cavities to the bottom can result in an outer shell having a greater thickness in the central region than at the edges or rim region, as shown in FIG. 2. In various embodiments, 2 or more layers of mixture are applied to the cavities 142 within the mold 140 to achieve a desired thickness for the outer shell 101.

After the mixture has been applied to the mold 140, the mixture may be allowed to further cool and/or cure, such as to a temperature close to room temperature. As the mixture cools and/or cures, it transitions from a liquid state to a solid state to form a portion 102, 104 of the outer shell 101. Once the mixture has solidified, the portion 102, 104 of the outer shell 101 can be removed from the mold 140. Contents 122, including one or more tea bags 124 and/or one or more additives 126, 128 can thereafter be added to the portion 102, 104 of the outer shell 101. After the contents 122 are loaded into the portion 102, 104 of the outer shell 101, two portions 102, 104 can be coupled or otherwise joined together as previously discussed to form a tea globe 100. If desired, colorants and/or decorative elements 120 can be applied to the outer shell 101 as previously discussed.

In certain embodiments, optional mold inserts 144 can be used to aid in forming the portion 102, 104 of the outer shell 101. The optional mold inserts 144 can be disposed in the cavities 142 of the mold 144 after the mixture is applied to the cavities 142. The optional mold inserts 144 can include a substantially hemispherical surface and can define the interior surface of the portion 102, 104 being molded in the cavity 142. The optional mold inserts 144 can also include an elongate member for grasping to aid in removing the molded portion 102, 104 from the cavity 142. For instance, the molded portion 102, 104 may be temporarily bonded to the optional mold insert 144 such that it can be removed from the cavity 142 as the user withdraws the optional mold insert 144 from the cavity 142. The molded portion 102, 104 can thereafter be removed from the optional mold insert 144 and used to form a tea globe 100 as set forth above.

Non-limiting examples of various embodiments disclosed herein are presented in the examples below:

### EXAMPLE 1

### Manufacturing a Tea Globe

Tea globes were formed in accordance with the following procedures. A mixture of about 20% vol corn syrup, 70% vol vegan sugar, and 10% vol water was mixed and heated to a hard crack temperature of about 300° F. After heating the mixture to about 300° F., the mixture was allowed to cool for one to two minutes until the mixture stopped boiling. The mixture was then poured into a mold having hemispherical cavities such that the mixture flowed down the sides of the cavities and towards the centers thereof. A second layer of the mixture was then applied to the cavities above the first layer and the mixture was allowed to cool and solidify. After solidifying, the hemispherical portions were removed from the mold cavities. The hemispherical portions were generally hollow and had a varying thickness, with the center region having a greater thickness than the rim or edge regions. Tea bags were then added into the cavities within the hemispherical portions. Remaining portions of the heated, liquid mixture were then applied to the rims of the hemispherical portions and second hemispherical portions were coupled thereto to form a plurality of tea globes. The tea globes were thereafter airbrushed or otherwise painted with a colorant to achieve a desired color.

### EXAMPLE 2

### Use of a Tea Globe

During use, a tea globe from Example 1 was submerged in a pitcher of water. The water was stirred and the outer shell of the tea globe began to dissolve. The outer shell first dissolved at the central region having the lowest thickness. Upon dissolution of the central region, the hemispherical portions opened and released the tea bag from the tea globe. The water was stirred to distribute the flavoring and then consumed.

References to approximations are made throughout this specification, such as by use of the terms “about.” For each such reference, it is to be understood that, in some embodiments, the value, feature, or characteristic may be specified without approximation. For example, where qualifiers such as “about” or “substantially” are used, these terms include within their scope the qualified words in the absence of their qualifiers. All disclosed ranges also include both endpoints.

Reference throughout this specification to “an embodiment” or “the embodiment” means that a particular feature, structure, or characteristic described in connection with that embodiment is included in at least one embodiment. Thus, the quoted phrases, or variations thereof, as recited throughout this specification are not necessarily all referring to the same embodiment.

Similarly, it should be appreciated that in the above description of embodiments, various features are sometimes grouped together in a single embodiment, figure, or description thereof for the purpose of streamlining the disclosure. This method of disclosure, however, is not to be interpreted as reflecting an intention that any claim require more features than those expressly recited in that claim. Rather, as the following claims reflect, inventive aspects lie in a combination of fewer than all features of any single foregoing disclosed embodiment.

The claims following this written disclosure are hereby expressly incorporated into the present written disclosure, with each claim standing on its own as a separate embodiment. This disclosure includes all permutations of the independent claims with their dependent claims. Moreover, additional embodiments capable of derivation from the independent and dependent claims that follow are also expressly incorporated into the present written description.

Without further elaboration, it is believed that one skilled in the art can use the preceding description to utilize the invention to its fullest extent. The claims and embodiments disclosed herein are to be construed as merely illustrative and exemplary, and not a limitation of the scope of the present disclosure in any way. It will be apparent to those having ordinary skill in the art, with the aid of the present disclosure, that changes may be made to the details of the above-described embodiments without departing from the underlying principles of the disclosure herein. In other words, various modifications and improvements of the embodiments specifically disclosed in the description above are within the scope of the appended claims. The scope of the invention is therefore defined by the following claims and their equivalents.

What is claimed is:

1-12. (canceled)

13. A method of forming a tea globe, comprising:
forming a mixture comprising glucose syrup and sugar;
heating the mixture to a hard crack temperature;
applying the mixture to a mold cavity;
cooling the mixture such that the mixture forms an edible hemispherical shell, wherein a thickness at a central region of the edible hemispherical shell is greater than a thickness at a rim region of the edible hemispherical shell;
removing the edible hemispherical shell from the mold cavity; and
coupling the rim region of the edible hemispherical shell with a rim region of a second edible hemispherical shell to form a substantially spherical edible outer shell, wherein a thickness at a central region of the second edible hemispherical shell is greater than a thickness at the rim region of the edible second hemispherical shell.

14. The method of claim 13, further comprising:
disposing one or more tea bags, loose leaf teas, powdered teas, or blooming teas into the hemispherical shell before coupling the hemispherical shell with the second hemispherical shell.

15. The method of claim 13, wherein the mixture is heated to a temperature of between about 290° F. and about 310° F.

16. The method of claim 15, wherein the mixture is heated to a temperature of between about 295° F. and about 305° F.

17. The method of claim 13, wherein the mixture comprises between 15% and 35% vol of glucose syrup.

18. The method of claim 13, wherein the thickness at the central region of the hemispherical shell is between about 0.3 mm and about 2 mm, and the thickness at the rim region of the hemispherical shell is between about 0.1 mm and about 0.5 mm.

19. The method of claim 18, wherein the thickness at the central region of the hemispherical shell is more than two times greater than the thickness at the rim region of the hemispherical shell.

20. The method of claim 13, wherein the rim region of the hemispherical shell is coupled to a rim region of the second hemispherical shell, and wherein the tea globe is configured to dissolve at the rim regions of the first and second hemispherical shells prior to dissolving at the central regions of the first and second hemispherical shells.

21. The method of claim 13, further comprising:
disposing one or more decorative elements on the hemispherical shell.

22. The method of claim 13, further comprising:
disposing one or more additives within the hemispherical shell.

23. The method of claim 13, further comprising:
disposing one or more of a Cannabis flower, concentrate, liquid, or extract within the hemispherical shell.

24. The method of claim 13, wherein the hemispherical shell is colored with a colorant.

25. A method of forming a tea globe, comprising:
forming a mixture comprising glucose syrup and sugar;
heating the mixture;
applying the mixture to a mold cavity;
cooling the mixture such that the mixture forms an edible hemispherical shell, wherein a thickness at a central region of the edible hemispherical shell is greater than a thickness at a rim region of the edible hemispherical shell, wherein the thickness at the central region of the edible hemispherical shell is between about 0.3 mm and about 2 mm, and the thickness at the rim region of the edible hemispherical shell is between about 0.1 mm and about 0.5 mm;
removing the edible hemispherical shell from the mold cavity;
disposing one or more tea bags, loose leaf teas, powdered teas, or blooming teas into the edible hemispherical shell; and
coupling the rim region of the hemispherical shell with a rim region of a second edible hemispherical shell to form a substantially spherical edible outer shell.

26. The method of claim 25, wherein the mixture is heated to a temperature of between about 290° F. and about 310° F.

27. The method of claim 25, wherein the mixture comprises between 15% and 35% vol of glucose syrup.

28. The method of claim 25, wherein a thickness at a central region of the second hemispherical shell is greater than a thickness at a rim region of the second hemispherical shell.

29. The method of claim 28, wherein the rim region of the hemispherical shell is coupled to a rim region of the second hemispherical shell, and wherein the tea globe is configured to dissolve at the rim regions of the first and second hemispherical shells prior to dissolving at the central regions of the first and second hemispherical shells.

30. The method of claim 25, further comprising:
disposing one or more of a Cannabis flower, concentrate, liquid, or extract within the hemispherical shell.

31. A method of forming a tea globe, comprising:
forming a mixture comprising glucose syrup and sugar;
heating the mixture;
applying a first layer of the mixture to a mold cavity;
applying a second layer of the mixture on the first layer;
cooling the mixture such that the mixture forms an edible hemispherical shell, wherein a thickness at a central region of the edible hemispherical shell is greater than a thickness at a rim region of the edible hemispherical shell, wherein the thickness at the central region of the edible hemispherical shell is more than two times greater than the thickness at the rim region of the edible hemispherical shell;
removing the edible hemispherical shell from the mold cavity;
disposing one or more tea bags, loose leaf teas, powdered teas, or blooming teas into the edible hemispherical shell before coupling the rim region of the edible hemispherical shell with the second hemispherical shell; and
coupling the rim region of the edible hemispherical shell with a rim region of a second edible hemispherical shell to form a substantially spherical edible outer shell, wherein the rim region of the hemispherical shell is coupled to a rim region of the second hemispherical shell, and wherein the tea globe is configured to dissolve at the rim regions of the first and second hemispherical shells prior to dissolving at the central regions of the first and second hemispherical shells.

32. The method of claim 31, further comprising:
disposing one or more of a Cannabis flower, concentrate, liquid, or extract within the hemispherical shell.
